(19) United States
(12) Patent Application Publication
(10) Pub. No.: US 2008/0083879 A1
(43) Pub. Date: Apr. 10, 2008

(54) Electronic Device for Detecting Intensity of Rays

(76) Inventor: Ching-Ting Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/830,854

(22) Filed: Jul. 31, 2007

(30) Foreign Application Priority Data
Oct. 4, 2006 (TW) 095136831

(51) Int. Cl. G01J 1/42; G01J 1/00

(52) U.S. Cl. 250/372; 250/336.1

(57) ABSTRACT

An electronic device for detecting intensity of rays includes a housing having a hole, a filter lens installed on the hole for filtering light and passing through a specific ray, a photosensor installed at a position corresponding to the hole in the housing for receiving the specific ray and generating a corresponding current, and a decision module electrically connected to the photosensor for determining the intensity of the specific ray according to the current generated by the photosensor.

### BACKGROUND OF THE INVENTION

1. Field of the Invention

The present invention relates to a ray-intensity detection device, and more particularly, to a precise and instantaneous ray-intensity detection device using a filter lens, a photosensor, and a voltage controlled oscillator.

2. Description of the Prior Art

Development of science and technology not only brings human beings a comfortable life, but also changes nature. Due to the deterioration of the ozone layer, the effect of the ultraviolet (UV) rays on the health of human beings draws more and more attentions. According to scientific research, exposure to too many UV rays may damage human's skin and sight. For example, after being irradiated with strong UV rays, the epidermis produces chemical media and releases the chemical media to the derma, causing blood vessel dilatation and erythema on the skin. As research of medical science shows, the erythema caused by UV rays is different from that caused by a burn. The erythema caused by UV rays disappears very slowly, and may turn into black spots or induce skin cancer. Moreover, strong UV rays also damage eye tissue, cause conjunctivitis, keratitis, and damage crystalline lenses, which are reasons that induce cataracts. According to statistics, the cataract is the most illness leading to ablepsia. Therefore, preventing from being irradiated with too many UV rays is the best way to help prevent cataracts. However, except for UV predictions provided by a weather bureau, there are no other credible and referable UV indexes. Furthermore, although strong UV rays are usually present on sunny days, people may also suffer from too much exposure to UV rays on a cloudy day or even indoors owing to the invisibility of UV rays. In addition, some lamps also emit UV rays, so UV threats are everywhere in our daily life. So, if UV rays can be detected anytime and anywhere with a mobile communications device, people can protect themselves at the right moment, so as to prevent UV threats.

The prior art UV detection device can be divided into two types. One is utilizing TiO₂ for receiving UV energy, and thus the intensity of UV rays can be determined by observing color changes of silver ions. Nevertheless, such way is not precise enough. The other type is utilizing photosensitive resistor, which varies resistance corresponding to the intensity of UV rays, so that the intensity of UV rays can be determined by comparing voltages generated by the photosensitive resistor. For example, please refer to FIG. 1, which illustrates a prior art UV detection device 100. The UV detection device 100 includes a photosensitive resistor 102, a resistor 104, and a comparison circuit 106. The photosensitive resistor 102 is a negative photosensitive resistor, meaning that as the intensity of UV rays is getting stronger, the resistance of the photosensitive resistor 102 becomes smaller, and thus current and output voltage V_{UV} of the resistor 104 become greater. Therefore, the comparison circuit 106 can compare the output voltage V_{UV} with a reference voltage V_{ref} for determining the intensity of UV rays.

Please refer to FIG. 2, which illustrates resistance variation of the photosensitive resistor 102 in FIG. 1. When the photosensitive resistor 102 is not exposed to UV rays, the resistance keeps in a value R0. At time t1, the photosensitive resistor 102 begins to be irradiated by UV rays, and the resistance of the photosensitive resistor 102 declines to a value Rs (at time t2). Then, at time t3, the UV rays is ceased irradiating, but it take times for the photosensitive resistor 102 to recover an original state, i.e. until time t4, the resistance of the photosensitive resistor 102 will not recover to the value R0. In the other words, the UV detection device 100 can determine the energy of UV rays by the photosensitive resistor 102, but it cannot instantaneously react due to the long recovery time (time t3 to time t4) of the photosensitive resistor 102.

In short, the prior art cannot precisely and instantaneously detect the intensity of UV rays due to the long recovery time of the photosensitive resistor. Moreover, since the UV rays cannot be observed by naked eyes, the prior art cannot prevent users from the harm of UV rays.

### SUMMARY OF THE INVENTION

It is therefore a primary objective of the claimed invention to provide an electronic device for detecting intensity of rays and related mobile communications device.

The present invention discloses an electronic device for detecting intensity of rays. The electronic device comprises a housing having a hole, a filter lens installed on the hole for filtering a specific ray, a photosensor installed at a position corresponding to the hole in the housing for receiving the specific ray and generating a current corresponding to the specific ray, and a decision module electrically connected to the photosensor for determining the intensity of the specific ray according to the current generated by the photosensor.

The present invention discloses a mobile communications device capable of detecting intensity of rays. The mobile communications device comprises a housing having a hole, a mobile communications module for performing mobile communication functions, an image reception device installed on the hole and including a lens, a photosensor, and an image processing circuit, a filter lens capable of being switched on the lens for filtering a specific ray, and a decision module electrically connected to the photosensor for determining the intensity of the specific ray according to the current generated by the photosensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art UV detection device.

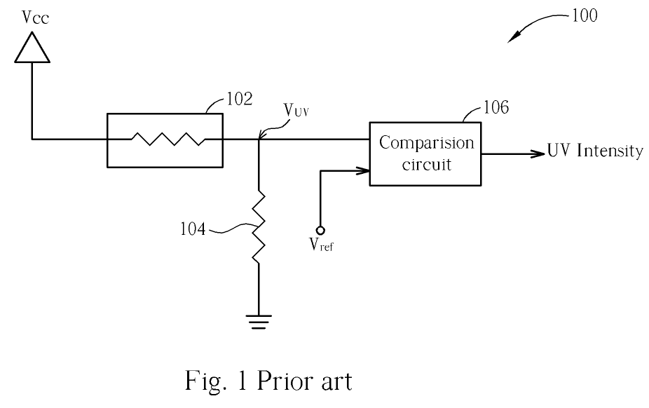

FIG. 2 is a diagram of resistance variation of a photosensitive resistor shown in FIG. 1.

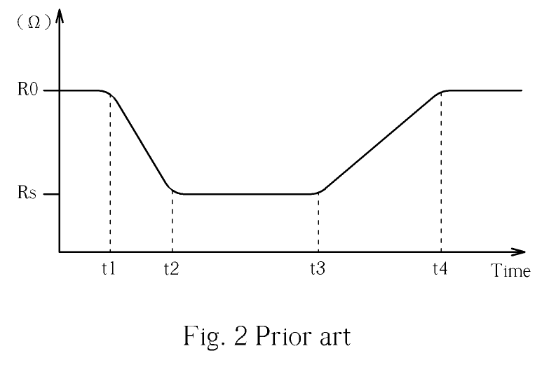

FIG. 3 is a diagram of a ray-intensity detection device in accordance with a first embodiment of the present invention.

FIG. 4 is a diagram of a decision module in accordance with the present invention.

FIG. 5 is a diagram of a mobile communications device capable of detecting intensity of rays in accordance with a second embodiment of the present invention.

### DETAILED DESCRIPTION

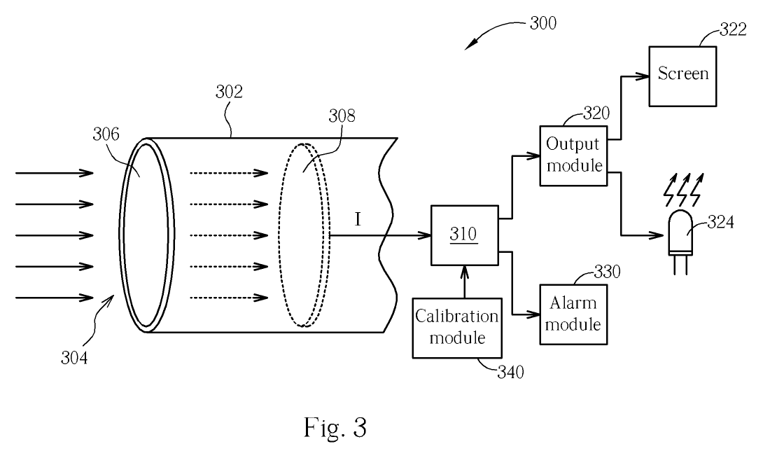

Please refer to FIG. 3, which illustrates a ray-intensity detection device 300 according to a first embodiment of the present invention. The ray-intensity detection device 300 is utilized for detecting intensity of specific rays, and comprises a housing 302, a filter lens 306, a photosensor 308, and a decision module 310. The housing 302 includes a hole 304 used for installing the filter lens 306. The filter lens 306 filters rays having wavelengths within a specific range, such as UV rays and infrared rays. As shown in FIG. 3, the photosensor 308 is installed at a position corresponding to the hole 304 inside the housing 302. The photosensor 308 can receive rays passing through the filter lens 306, and generate a corresponding current I. The decision module 310 determines ray intensity according to the current I generated by the photosensor 308. For example, if the intensity of UV rays is needed to be detected, a wavelength range of rays capable of passing through the filter lens 306 can be set as 200 nm to 400 nm since the wavelength range of UV rays is 200 nm to 400 nm. Therefore, only UV rays can pass through the filter lens 306. On the other hand, the photosensor 308 can generate currents corresponding to intensities or wavelengths of received rays. As a result, the present invention can determine intensity of UV rays according to the current I with the decision module 310.

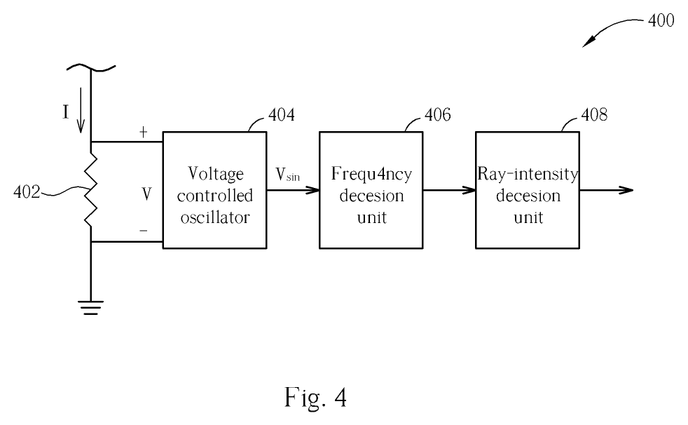

Therefore, in the ray-intensity detection device 300, the filter lens 306 can filter specific rays, and the photosensor 308 can generate the current I accordingly. Then, the decision module 310 determines the intensity of rays according to the value of the current I. Notice that, there is no limitation of implementations of the decision module 310 as long as the intensity of rays can be determined according to the current I. For example, please refer to FIG. 4, which is a diagram of a decision module 400 according to an embodiment of the present invention. The decision module 400 is utilized for realizing the decision module 310 shown in FIG. 3, and includes a resistor 402, a voltage controlled oscillator (VCO) 404, a frequency decision unit 406, and a ray-intensity decision unit 408. When the current I generated by the photosensor 308 passes through the resistor 402, the resistor 402 generates a corresponding voltage V to the VCO 404. The VCO 404 outputs an oscillation signal Vₛᵢₙ to the frequency decision unit 406, and varies the oscillation frequency of the oscillation signal Vₛᵢₙ according to the voltage V. The frequency decision unit 406 determines the frequency of the oscillation signal Vₛᵢₙ, and outputs a result to the ray-intensity decision unit 408. Then, according to the frequency of the oscillation signal Vₛᵢₙ, the ray-intensity decision unit 408 can determine the intensity of rays according to a preset table. Therefore, operations of the decision module 400 can be concluded as follows: the resistor 402 generates the voltage V according to the current I generated by the photosensor 308 in FIG. 3, the VCO 404 generates the oscillation signal Vₛᵢₙ with a frequency corresponding to the value of voltage V, the frequency of the oscillation signal Vₛᵢₙ is then obtained through the frequency decision unit 406, and finally, the intensity of rays can be determined by the ray-intensity decision unit 408 according to the frequency of the oscillation signal Vₛᵢₙ.

Therefore, the ray-intensity detection device 300 shown in FIG. 3 can determine ray intensity precisely with the high-sensitivity VCO 404 of in the decision module 400. That is, the present invention can detect ray intensity without using photosensitive resistors, and thus decrease detection time. In addition, the ray-intensity detection device 300 can further comprise an output module 320, an alarm module 330, or a calibration module 340. The output module 320 is used for outputting corresponding signals through a screen 322 or an indicating light 324 according to the result of the decision module 310 (or the decision module 400). The alarm module 330 is used for outputting an alarm signal when ray intensity determined by the decision module 310 (or the decision module 400) is greater than a preset value. The calibration module 340 is used for calibrating the decision module 310 (or the decision module 400).

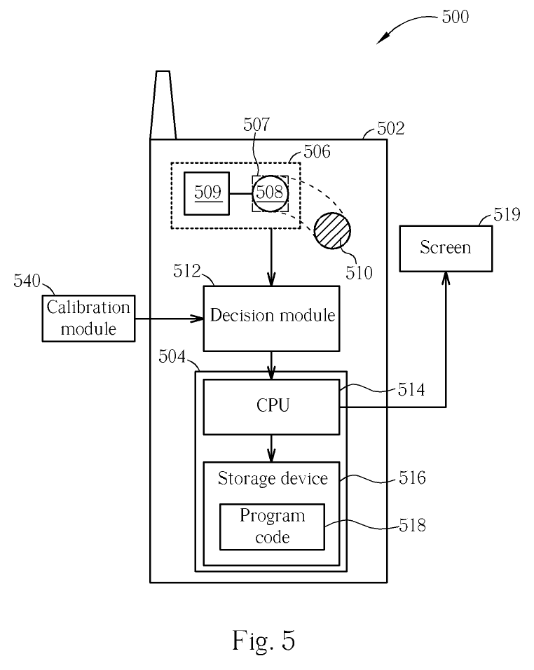

Please refer to FIG. 5, which is a diagram of a mobile communications device 500 capable of detecting the intensity of rays according to a second embodiment of the present invention. The mobile communications device 500 can be any mobile communications device, such as a mobile phone or a personal digital assistant. The mobile communications device 500 includes a housing 502, a mobile communications module 504, an image reception device 506, a filter lens 510, and a decision module 512. The housing 502 includes a hole for installing the image reception device 506. The image reception device 506 includes a lens 508, a photosensor 507, and an image processing circuit 509. The lens 508 is installed on the hole of the housing 502, and is utilized for generating images on the photosensor, which generates currents corresponding to red, blue, or green lights accordingly. The image processing circuit 509 then outputs an image according to the currents generated by the photosensor. The filter lens 510 can be switched on the lens 508 to filter rays having wavelengths within a specific range, such as UV rays, infrared rays, etc. For example, if the intensity of UV rays is going to be detected, a wavelength range of rays capable of passing through the filter lens 510 can be set as 200 nm to 400 nm since the wavelength range of UV rays is 200 nm to 400 nm. As a result, only UV rays can pass through the filter lens 510 after the filter lens 510 is switched on the lens 508. Therefore, rays focused on the photosensor are UV rays. Then, the decision module 512 determines the intensity of UV rays according to the current generated by the photosensor. The decision module 512 can be realized as the decision module 400 shown in FIG. 4. In the decision module 400, the VCO 404 and the frequency decision unit 406 can be replaced by circuits in a transceiver of the mobile communications device 500.

Moreover, the mobile communications module 504 comprises a central processing unit (CPU) 514 and a storage device 516. The storage device 516 stores program code 518 executed by the CPU 514. The program code 518 comprises steps for detecting the intensity of rays with the decision module 512 when the filter lens 510 is switched on the lens 508. Besides, according to the result of the decision module 512, the program code 518 can further include steps for outputting corresponding signals (such as sound, flash, or numbers), and adjusting brightness of a screen 519 of the mobile communications device 500 for saving power. Furthermore, the program code 518 can include steps for outputting an alarm signal when the result of the decision module 512 is greater than a preset value, or transmitting the information (such as exposure time and amount) to a health management center through the mobile communications module 504 for providing statistic data and reference information. Certainly, the mobile communications device 500 can also include a built-in or extra calibration module 540 for calibrating precision of the decision module 512.

As mentioned above, owing to the invisibility of UV rays, people may suffer from too much exposure to UV rays on a cloudy day or even indoors. In addition, some lamps also emit UV rays, so UV threats are everywhere in our daily life. So, if UV rays can be detected anytime and anywhere, people can protect themselves at the right moment, so as to prevent UV threats. However, the prior art cannot precisely and instantaneously detect the intensity of UV rays due to the long recovery time of the photosensitive resistor. In comparison, the present invention detects the intensity of UV rays using a filter lens for filtering specific rays, a photosensor for generating current corresponding to intensity of the specific ray, and a high-sensitivity voltage controlled oscillator. In addition to the intensity of UV rays, the intensities of other rays can also be detected (such as infrared rays) bye switching appropriate filter lens.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device for detecting intensity of rays comprising:
a housing having a hole;
a filter lens installed on the hole for filtering a specific ray;
a photosensor installed at a position corresponding to the hole in the housing for receiving the specific ray and generating a current corresponding to the specific ray; and
a decision module electrically connected to the photosensor for determining the intensity of the specific ray according to the current generated by the photosensor.

2. The electronic device of claim 1, wherein the decision module comprises:
a resistor electrically connected to the photosensor for generating a voltage difference between two ends of the resistor when the current generated by the photosensor passes through the resistor; and
a voltage controlled oscillator (VCO) electrically connected to the two ends of the resistor for generating an oscillating signal according to the voltage difference between the two ends of the resistor;
a frequency decision unit electrically connected to the VCO for determining a frequency of the oscillation signal; and
a ray-intensity decision unit electrically connected to the frequency decision unit for determining the intensity of the specific ray according to the frequency of the oscillation signal determined by the frequency decision unit.

3. The electronic device of claim 1, wherein a wavelength of the specific ray is in a specific range.

4. The electronic device of claim 1 further comprising an output module coupled to the decision module for outputting a decision signal according to the intensity determined by the decision module.

5. The electronic device of claim 4, wherein the output module displays the intensity with a screen.

6. The electronic device of claim 4, wherein the output module displays the intensity with an indicating light.

7. The electronic device of claim 1 further comprising an alarm module coupled to the decision module for outputting an alarm signal when the decision module determines that the intensity of the specific ray is greater than a preset value.

8. The electronic device of claim 1 further comprising a calibration module for calibrating the decision module.

9. The electronic device of claim 1, wherein the electronic device is installed in a mobile communications device.

10. A mobile communications device capable of detecting intensity of a ray comprising:
a housing having a hole;
a mobile communications module for performing mobile communication functions;
an image reception device installed on the hole, comprising:
a lens installed on the hole;
a photosensor installed at a position corresponding to the lens inside the housing for receiving the ray passing through the lens and generating a current corresponding to the ray; and
an image processing circuit for outputting an image according to the current generated by the photosensor;
a filter lens capable of being switched on the lens for filtering a specific ray; and
a decision module electrically connected to the photosensor for determining the intensity of the specific ray according to the current generated by the photosensor.

11. The mobile communications device of claim 10, wherein the decision module comprises:
a resistor electrically connected to the photosensor for generating a voltage difference between two ends of the resistor when the current generated by the photosensor passes through the resistor; and
a voltage controlled oscillator (VCO) electrically connected to the two ends of the resistor for generating an oscillating signal according to the voltage difference between the two ends of the resistor;
a frequency decision unit electrically connected to the VCO for determining a frequency of the oscillation signal; and
a ray-intensity decision unit electrically connected to the frequency decision unit for determining the intensity of the specific ray according to the frequency of the oscillation signal determined by the frequency decision unit.

12. The mobile communications device of claim 10, wherein a wavelength of the specific ray is in a specific range.

13. The mobile communications device of claim 10, wherein the mobile communications module comprises:
a central processing unit coupled to the decision module; and
a storage device, coupled to the central processing unit, for storing program code, the program code comprising determining the intensity of the specific ray with the decision module when the mobile communications device receives a command of detecting light and the filter lens is switched on the lens.

14. The mobile communications device of claim 13, further comprising a screen coupled to the central processing unit, wherein the program code further comprises adjusting brightness of the screen according to the intensity determined by the decision module.

15. The mobile communications device of claim 13, wherein the program code further comprises outputting a decision signal according to the intensity determined by the decision module.

16. The mobile communications device of claim 13, wherein the program code further comprises outputting an alarm signal when the decision module determines that the intensity is greater than a preset value.

17. The mobile communications device of claim 10 further comprising a calibration module for calibrating the decision module.

18. The mobile communications device of claim 10 being a mobile phone.

19. The mobile communications device of claim 10 being a personal digital assistant.
